(19) United States
(12) Patent Application Publication
(10) Pub. No.: US 2014/0338533 A1
(43) Pub. Date: Nov. 20, 2014

(54) METHOD FOR SEPARATING OVERSPRAY

(71) Applicant: Michael Schlipf, Goppingen (DE)

(72) Inventor: Michael Schlipf, Goppingen (DE)

(73) Assignee: EISENMANN AG, Böblingen (DE)

(21) Appl. No.: 14/345,317

(22) PCT Filed: Sep. 5, 2012
(86) PCT No.: PCT/EP2012/003708

§ 371 Date: Jun. 13, 2014

(30) Foreign Application Priority Data
Sep. 17, 2011 (DE) 10 2011 113 708.8

(51) Int. Cl. B05B 15/12; B05B 15/04

(52) U.S. Cl. CPC B05B 15/1262; B05B 15/0412
USPC 95/205

(57) ABSTRACT

A method for separating overspray produced during the painting of objects, the overspray is absorbed by an air flow and transported to a separating surface of a separating device over which a separating liquid flows. A large part of the overspray merges with the separating liquid, is transported away by said separating liquid, and is removed from the separating liquid by separation. Separating liquid is fed to the separating surface using a dispensing device, which is arranged so that the total discharge mass flow (GM) of the separating liquid is dependent at least on the viscosity of the separating liquid. Furthermore, separating liquid having a predetermined inlet mass flow (ZM) is fed to the dispensing device, wherein the inlet mass flow (ZM) of the dispensing device is equal to the total mass flow (GM), and the viscosity of the separation liquid during the operation of the separation device is calculated.

The invention relates to a method for separating, by means of a separating device, overspray produced during the painting of objects, in which
a) the overspray is taken up by an air stream and transported to a separating surface of the separating device over which a separating liquid flows, whereby a large part at least of the solids of the overspray is transferred to the separating liquid, is transported away by the separating liquid and is removed from the separating liquid by separation;
b) separating liquid is fed to the separating surface by means of a delivery device which delivers separating liquid with a total discharge mass flow rate and is so configured that the total discharge mass flow rate of the separating liquid is dependent at least on the viscosity of the separating liquid;
   wherein
c) separating liquid is fed to the delivery device with a predetermined feed mass flow rate.

During the manual or automatic application of paints to objects, a portion of the paint stream, which portion generally contains both solids and solvents and/or binders, is not applied to the object. This portion of the stream is called “overspray” in the art. The overspray is captured by the air stream in the spray booth and fed to a separation operation.

In plants with relatively high paint consumption in particular, for example in plants for painting motor vehicle bodies, wet separation systems are preferably used, in which methods of the type mentioned at the beginning are employed.

In order that the paint particles taken up by the separating liquid can be guided away from the separating surface without problems, the separating liquid must fulfil specific criteria. These include, for example, the criterion that the adhesive action of the paint particles must be eliminated so that, if the particles come into contact with the separating surface through the separating liquid, they do not adhere thereto.

A method of the type mentioned at the beginning is known, for example, from DE 10 2008 046 409 B4 or DE 10 2008 046 414 A1, where a water- or oil-based separating liquid having a detackifying action with respect to the overspray particles is used to that end. The separating liquid is fed via a feed line into a trough and is discharged therefrom by means of rotating rollers, which project into the separating liquid.

It is to be ensured that the separating surface is wetted as evenly as possible and without sags or runs, and it is particularly desirable for the separating liquid to be able to flow down the separating surface in a largely laminar manner, that is to say for a thin film that moves evenly downwards to be formed on the separating surface.

The latter properties are greatly dependent on the viscosity of the separating liquid, which should therefore be monitored during operation of the separating device. This is carried out, for example, in DE 10 2008 046 409 B4 by a conventional viscometer, by means of which the viscosity of the separating liquid is determined in the feed of the separating liquid to the delivery device.

In practice, the separating liquid is guided in a loop and regenerated after it has taken up the overspray particles at the separating surface of the separating device. However, paint residues are still distributed in the separating liquid even after the regeneration. These can lead to the sensors of the viscometer being impaired and the viscosity measurement yielding incorrect results.

Alternatively, it is possible to take samples from the separating liquid guided in a loop and measure them. However, the outlay in terms of apparatus and personnel is very high in this case.

The object of the invention is, therefore, to develop further a method of the type mentioned at the beginning in such a manner that a reliable determination of the viscosity of the separating liquid can be carried out during operation of the separating device, without the occurrence of the difficulties mentioned above.

In a method of the type mentioned at the beginning, this object is achieved in that
d) the separating device is operated in such a manner that the feed mass flow rate of the delivery device is equal to the total discharge mass flow rate of the delivery device, and the viscosity of the separating liquid is calculated during operation of the separating device.

According to the invention, it has been found that the viscosity of the separating liquid can be calculated if the quantity of separating liquid discharged is dependent on its viscosity, as is the case, for example, in the roller principle according to the prior art. This will be discussed again in greater detail below.

Consequently, it is advantageous if the discharge of separating liquid to the separating surface takes place by means of at least one roller projecting into the separating liquid and the discharge mass flow rate AM=c v_{w} η, where c is a proportionality factor, v_{w} is the speed of rotation of the roller and η is the viscosity of the separating liquid.

It can be advantageous if the delivery device feeds separating liquid to the separating surface in a first manner with a discharge mass flow rate that is dependent at least on the viscosity of the separating liquid, and the delivery device delivers separating liquid in at least a second manner with a secondary mass flow rate, and the secondary mass flow rate is measured with a measuring device during operation of the separating device. In the case of the roller principle discussed above, discharge via the rollers, for example, represents the feeding of the separating liquid to the separating surface.

Delivery in a second manner can then be provided, for example, by an overflow, so that the level of separating liquid in the trough remains largely constant.

Exemplary embodiments of the invention will be explained in greater detail below by means of the drawing, in which:

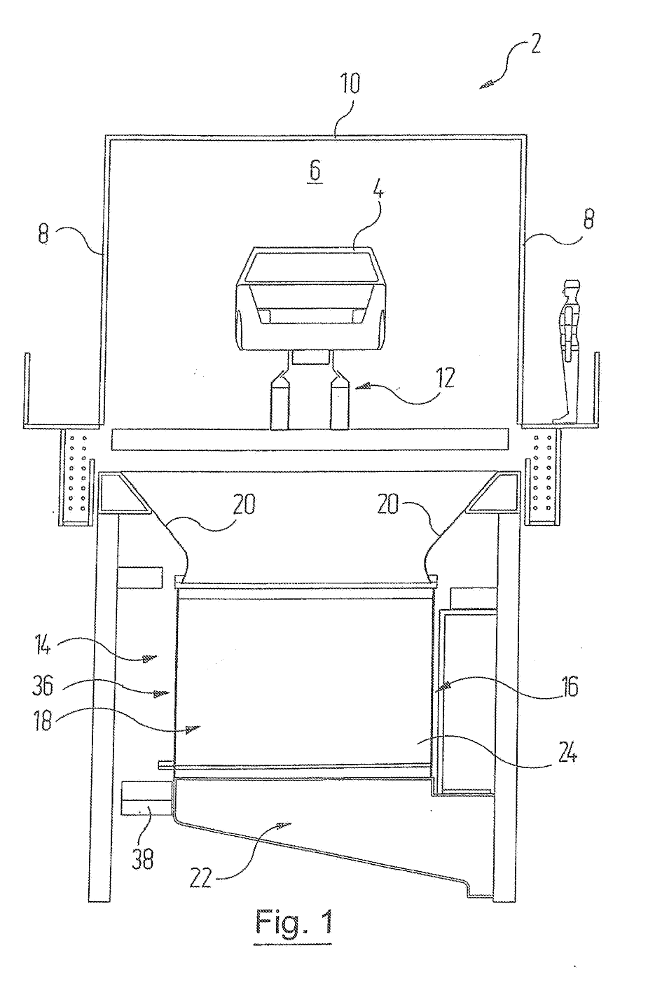

FIG. 1 shows a front view of a painting booth of a surface treatment plant with an overspray separating device;

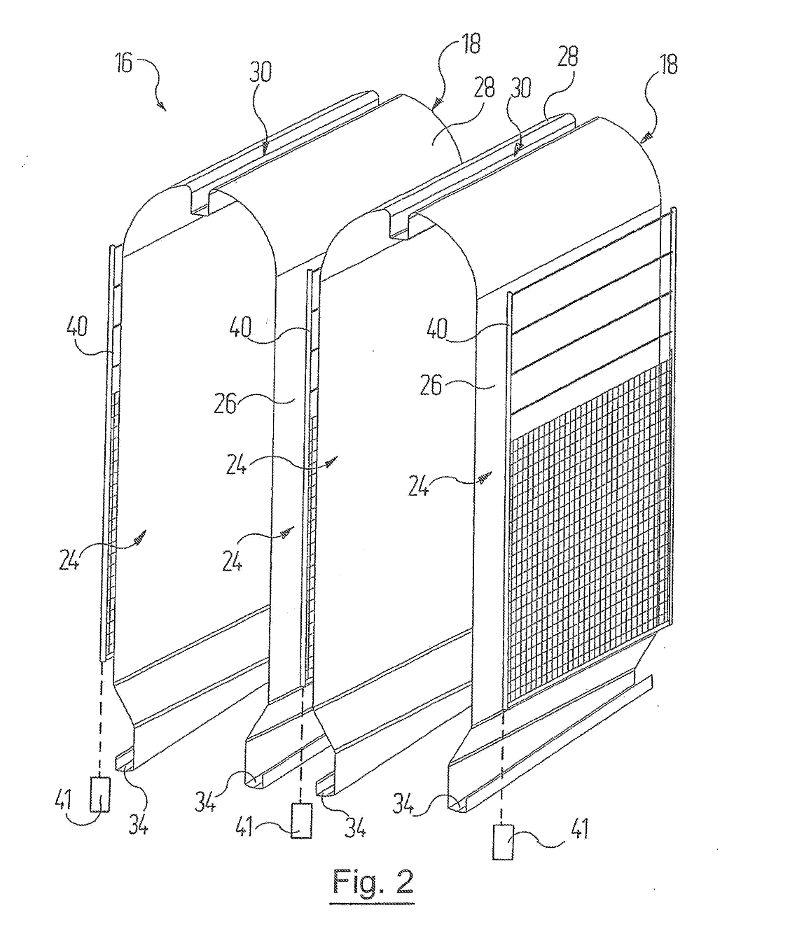

FIG. 2 shows a perspective view of two separating units and of three electrode devices of the separating device of FIG. 1;

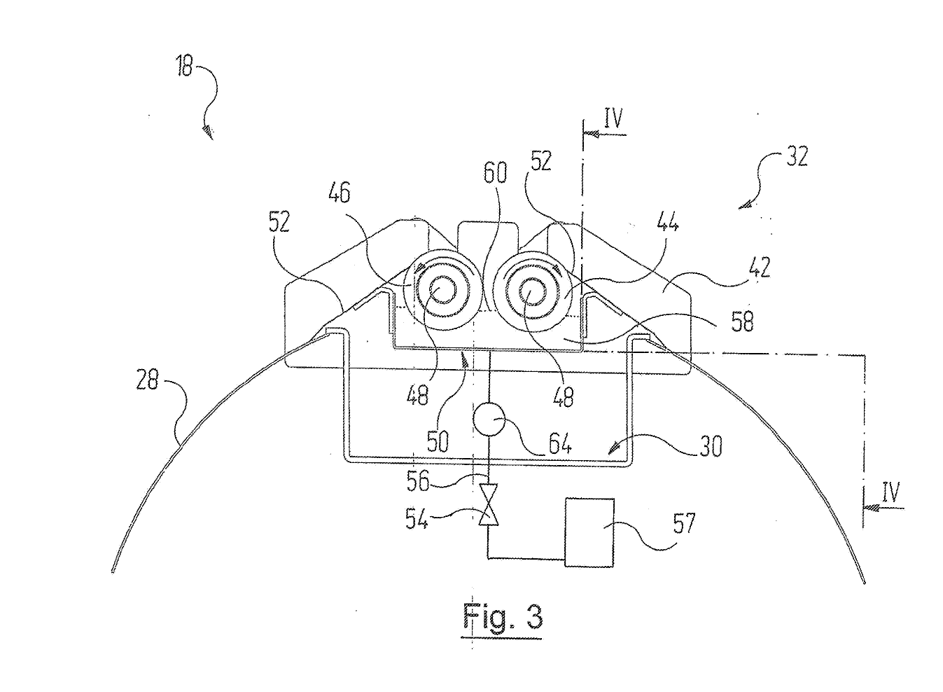

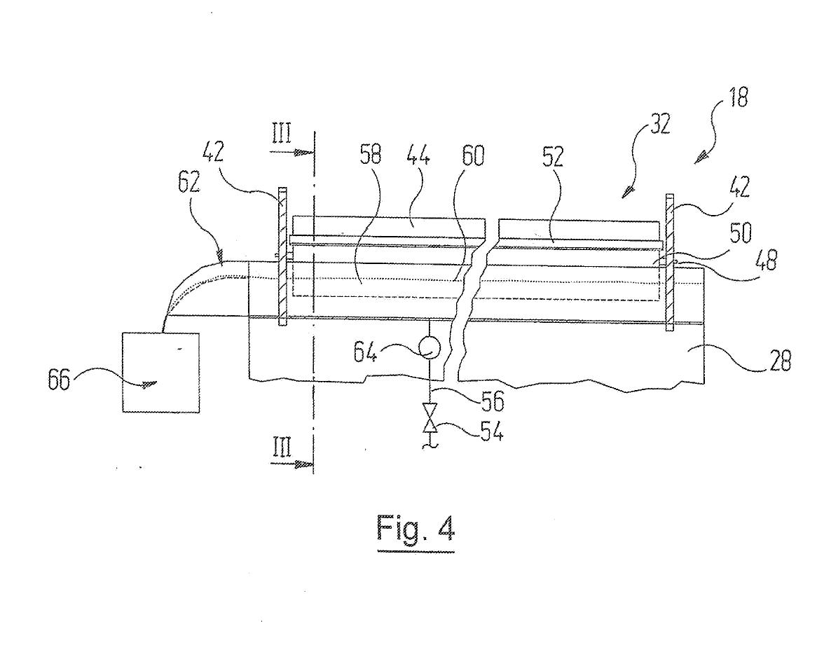

FIG. 3 shows a sectional view of a delivery device of the separating units, by means of which a separating liquid can be fed to separating surfaces of the separating units, along cutting line III-III in FIG. 4;

FIG. 4 shows a sectional view, partially see-through, of the delivery device along the angled cutting line IV-IV in FIG. 3;

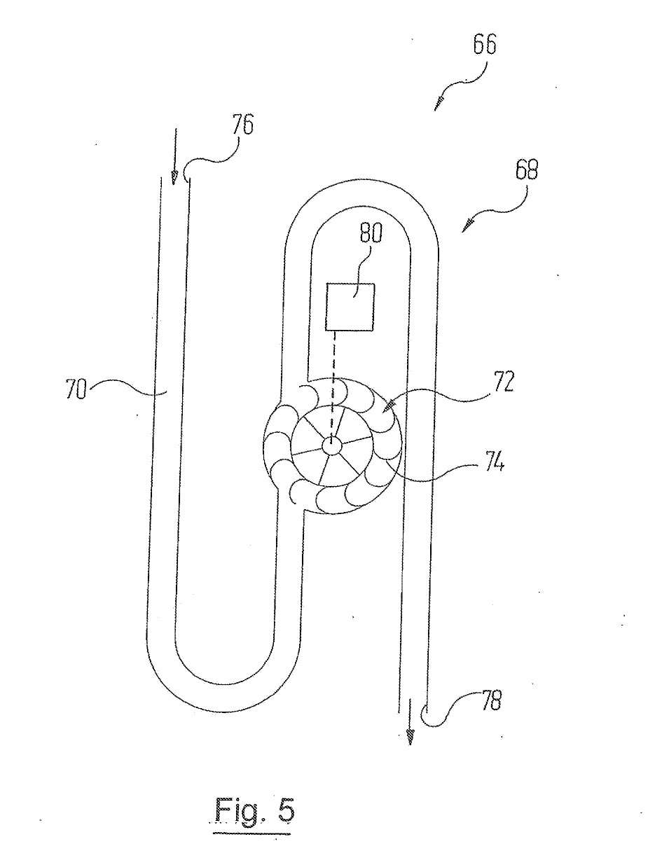

FIG. 5 shows, schematically, a first exemplary embodiment of a device for determining the quantity of separating liquid lost per unit time through overflow;

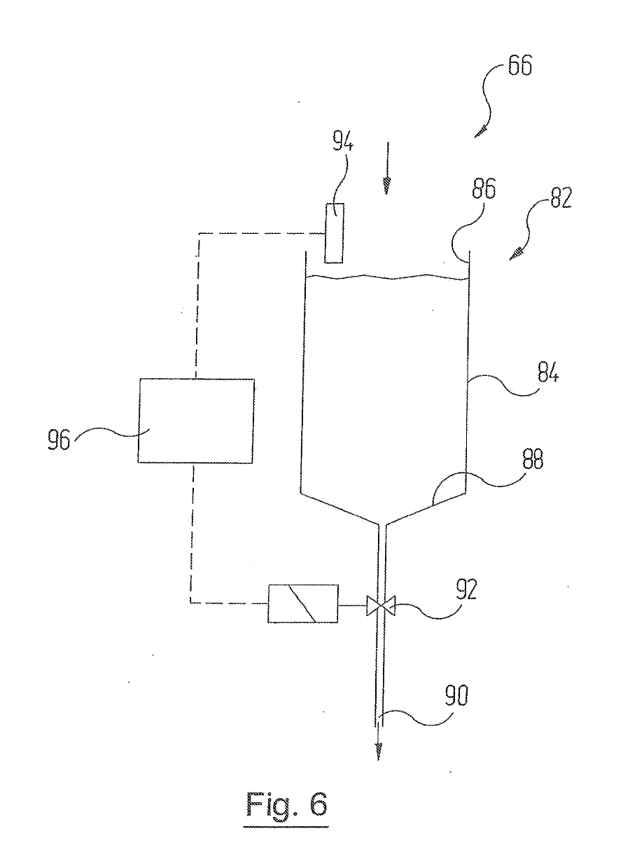

FIG. 6 shows, schematically, a second exemplary embodiment of a device for determining the quantity of separating liquid lost per unit time through overflow.

Reference will first be made to FIG. 1. In FIG. 1, 2 denotes generally a painting booth of a surface treatment plant, in which motor vehicle bodies 4 are painted after they have been, for example, cleaned and degreased in the pretreatment stations (not shown) arranged upstream of the painting booth 2.

The painting booth 2 comprises a painting tunnel 6 arranged at the top, which painting tunnel 6 is delimited by vertical side walls 8 and a horizontal booth ceiling 10 but is open at the end faces and at the bottom so that booth waste air laden with overspray is able to flow downwards. The booth ceiling 10 is formed in the conventional manner as the lower boundary of the air feed chamber (not shown) with a filter ceiling.

Motor vehicle bodies 4 that are to be painted can be transported by means of a conveyor system 12, which will not be discussed further here, from the entry side of the painting tunnel 6 to its exit side. Inside the painting tunnel 6 there are application devices (not shown), by means of which paint can be applied in a manner known per se to the motor vehicle bodies 4.

Beneath a bottom opening of the painting tunnel 6 there is a separating chamber 14 which is open at the top to the painting tunnel 6 and in which paint overspray produced during the painting operation is separated.

In the separating chamber 14 there is arranged a separating device 16 having a plurality of separating units 18 which are arranged one behind the other in the longitudinal direction of the separating chamber 14 and which will be discussed in greater detail below.

The booth air leaving the painting tunnel 6 and laden with overspray is passed over air deflectors 20 to the separating device 16 and flows through the separating device 16 from top to bottom, whereby it is freed of entrained overspray particles. The cleaned booth air then passes into a flow-off region 22, which is formed by air deflectors and is arranged beneath the separating device 16 and from where, optionally after a certain degree of conditioning, it can be fed to the painting tunnel 6 again as fresh air. The conditioning can in particular be an adjustment of the temperature and of the humidity and optionally the removal of solvents still present in the air.

In FIG. 2, two adjacent separating units 18 of the separating device 16 are shown. As can be seen in the figure, a separating unit 18 comprises two parallel rectangular side plates 24 which are spaced apart from one another. The outer surfaces of the side plates 24 form separating surfaces 26 down which there flows, during operation of the separating device 16, a separating liquid suitable for taking up solids particles from the paint overspray produced during the painting operation.

The side plates 24 are connected together at their opposing upper end edges by a curved section 28, the clear outer contour of which corresponds in cross-section to a semi-circle and which forms the top face of the separating unit 18.

At its apex, the curved section 28 of the separating units 18 is in the form of a bearing channel 30 which is open at both end faces and in which there is arranged a delivery device 32, by means of which separating liquid can be fed to the separating surfaces 26 and an exemplary embodiment of which is shown only in FIGS. 3 and 4 for the sake of clarity. This will be discussed in greater detail below.

At their bottom edges, the side plates 24 each carry a drain channel 34 which runs parallel to the side plates 24 of the separating units 18 and slopes downwards in the direction towards an end face 36 of the separating unit 18.

As can be seen in FIG. 1, at the lower-lying end of the drain channels 34 there is a collecting channel 38 into which the separating liquid flows and which extends in the longitudinal direction of the painting booth 2. By way of the collecting channel 38, the separating liquid laden with overspray particles flows out of the painting booth 2 and can cleaning and reconditioning, in which the separating liquid is freed of the overspray particles. The separating liquid so regenerated is then fed to the separating device 18 again in a loop.

In the separating device 16, two adjacent separating units 18 are arranged with a distance maintained between them. In each case between two adjacent separating units 18 and at the free side plates 24 of the two outermost separating units 18 in the separating device 16 there extends an electrode device 40, each of which is connected to a high-voltage source 41. In a modification, the electrode devices 40 can also be fed by a single high-voltage source. The separating units 18 are at earth potential.

During the painting of the motor vehicle bodies in the painting tunnel 6, the booth air therein becomes laden with paint overspray particles. These can still be wet and/or tacky or can also already be more or less solid. The booth waste air laden with paint overspray flows through the bottom opening 12 of the painting tunnel 6 into the separating chamber 14.

The air is there deflected by the air deflectors 20 in the direction towards the separating device 16 and flows between adjacent separating units 18 in the direction towards the flow-off region 22.

The electrode devices 40 are so configured that corona discharges occur in a manner known per se, by which the overspray particles in the booth waste air flowing past are effectively ionised.

The ionised overspray particles then pass the side plates 24, which are at earth potential, of two adjacent separating units 18 and the electrode devices 40 running therebetween. As a result of the electric field formed there, the ionised overspray particles are separated at the separating surfaces 26 of the side plates 24 of the separating units 18 and are there taken up by the separating liquid flowing along them.

An exemplary embodiment of the delivery device 32 is shown in detail in FIGS. 3 and 4.

At each end face of the bearing channel 30 there is attached a bearing unit 42. The bearing units 42 support two rollers 44, 46, which run parallel to one another in the longitudinal direction of the bearing channel 30 while maintaining a distance in a horizontal plane.

The rollers 44, 46 can be driven by drive means (not shown) in such a manner that they rotate in different directions of rotation. This is shown in FIG. 3 by corresponding arrows.

The rollers 44, 46 project, with a region located beneath the plane defined by their axes of rotation 48, into a trough 50 which can be filled with the separating liquid, so that regions of the rollers 44, 46 then dip into the separating liquid. The trough 50 is fixed in the bearing channel 30 by connecting members (not shown). On either side of the trough 50 there are arranged spring steel sheets 52, which serve as run-off surfaces for the separating liquid. The spring steel sheets 52 rest with an upper outer edge against the outer lateral surface of the rollers 44, 46 and with an opposite lower outer edge against the curved section 28 of the separating unit 18. As the rollers 44, 46 rotate, separating liquid is thus stripped off at the spring steel sheets 52 and flows over them as a cohesive layer on both sides of the curved section 28 of the separating unit 18 and passes from there as a cohesive layer to the separating surfaces 26 thereof.

The trough 50 is supplied from beneath, by way of a feed line 56 provided with a flow-control valve 54, with the separating liquid coming from a reservoir 57, which is shown only in Figure 3, and the rollers 46 dip into the separating liquid. This can be seen in FIGS. 3 and 4, where the separating liquid is denoted 58 and the liquid level thereof in the trough 50 is denoted 60. In FIG. 4, the trough 50 is shown in a see-through view and the portion of the roller 44 projecting into the trough 50 is shown by a broken line.

At an end face of the separating unit 18 the trough 50 has an overflow channel 62, via which separating liquid 58 flows out of the trough 50 when the liquid level 60 of the separating liquid 58 reaches a specific level. In order that the liquid level 60 of the separating liquid 58 inside the channel 50 is always sufficiently high that the rollers 44, 46 always dip into separating liquid 58, the trough 50 is continuously fed with a quantity of separating liquid 58 corresponding to that delivered from the trough 50 by discharge via the rollers 44, 46 and the overflow channel 62. The quantity of separating liquid fed to the channel 50 is determined by means of a flow meter 64, as is known per se and which is arranged in the feed line 56.

The delivery device 32 accordingly delivers separating liquid 58 in a first manner, namely via the rollers 44, 46, and in a second manner, namely via the overflow channel 62. The total quantity of separating liquid 58 that leaves the trough 50 per unit time is thus the sum of the discharge by the rollers 44, 46 and of the separating liquid 58 that flows out via the overflow channel 62.

The mass flow rate in kg s⁻¹ is here used as the feed quantity. Accordingly, the delivery device 32 delivers separating liquid 58 via the rollers with a discharge mass flow rate AM and via the overflow channel 62 with a secondary mass flow rate NM. The sum of the discharge mass flow rate AM and the secondary mass flow rate NM gives the total discharge mass flow rate GM.

By detecting the overflow quantity of separating liquid 58 per unit time, that is to say the secondary mass flow rate NM of the separating liquid, it is possible, with knowledge of the feed quantity per unit time as the feed mass flow rate ZM, to determine the discharge quantity via the rollers 44, 46 and thus the viscosity of the separating liquid 58, which will be explained in greater detail below. To this end, the overflow channel 62 guides the separating liquid 58 to a measuring device 66.

FIG. 5 shows a flow meter 68 as a first exemplary embodiment of the measuring device 66. This comprises a siphon-like tube 70, in which there is arranged a measuring chamber 72 with a paddle-wheel 74, through which the separating liquid 58 flows. Separating liquid 58 is fed to the tube 70 from the two drain channels 32 of a separating unit 18, for example via a funnel (not shown), at an upper inlet end 76, flows through the tube 70 and leaves it via an outlet end 78, from where it is guided into the collecting channel 38 of the separating device 16. The flow quantity through the line 70, and accordingly the overflow quantity per unit time of separating liquid 58 from the trough 50 of the delivery device 32 of a separating unit 18 in question, is proportional to the speed of the paddle-wheel 74; this is detected by a speed sensor 80, which is shown only schematically in FIG. 5.

FIG. 6 shows an interval measuring device 82 as a second exemplary embodiment of the measuring devices 66. In this case, the separating liquid 58 flows from the trough 50 via the overflow channel 62 into an intermediate container 84, which to this end has an upper inlet 86. The bottom 88 of the intermediate container tapers in the manner of a funnel to an outlet 90, which can be opened or closed, as desired, via a change-over valve 92.

The interval measuring device 82 additionally comprises a filling-level sensor 94, which communicates with a valve control system 96. Whenever the filling level of the separating liquid 58 in the intermediate container 84 reaches a predetermined maximum level, the filling-level sensor 94 transmits a corresponding output signal to the valve control system 96, which then opens the valve 92. Separating liquid 58 then flows out of the intermediate container 84 via the outlet 90 and is guided into the collecting channel 38 of the separating device 16.

When the separating liquid 58 in the intermediate container 84 reaches a minimum level, which is likewise predetermined, a corresponding output signal from the filling-level sensor 94 results in the valve 92 being closed. The level of the separating liquid 58 in the intermediate container 84 then rises again and the cycle begins anew.

Instead of detecting a minimum level, it is also possible for the valve 92 simply to be kept open for a sufficient length of time to ensure that the intermediate container 84 is completely empty when the valve 92 is closed again.

With knowledge of the measuring volume of the interval measuring device 82, the overflow quantity per unit time of separating liquid 58 from the trough 50 of the delivery device 32 of a particular separating unit 18 under consideration is given by the period between closing and opening of the valve 92. The measuring volume of the interval measuring device 74 is the volume in the intermediate container 76 between the minimum level and the maximum level.

Accordingly, both using the flow meter 68 and using the interval measuring device 82, values of the overflow quantity per unit time of the delivery device 32, and also changes in the overflow quantity over time, can be determined and detected.

Using the above-mentioned flow meter 64 in the feed line 56, the feed quantity of separating liquid into the trough 50 of the delivery device 32, and also changes in the feed quantity over time, can be determined and detected.

With knowledge of the feed quantity of separating liquid into the trough 50 of the delivery device 32, and with knowledge of the overflow quantity of separating liquid from the trough 50 of the delivery device 32, the viscosity of the separating liquid can then be calculated as follows:

As mentioned above, the total discharge mass flow rate GM of separating liquid of the delivery device 32 is the sum of the discharge mass flow rate AM by the rollers 44, 46, that is to say the quantity of separating liquid fed per unit time from the trough 50 by the rollers 44, 46, and the secondary mass flow rate NM in the form of the quantity of separating liquid flowing out of the trough 50 per unit time via the overflow channel 62.

Separating liquid is thereby fed to the separating surfaces 26 with the discharge mass flow rate AM=dm_{A}/dt [kg s⁻¹].

The discharge mass flow rate AM is proportional to the speed of rotation v_{w} [m s⁻¹] of the rollers 44, 46 and to the viscosity η [kg m⁻¹ s⁻¹] of the separating liquid. The speed of rotation of the rollers 44, 46 is the speed at which the roller surface passes the spring steel sheets 52. V_{w} =2 πf r, where f is the speed [s⁻¹] and r the radius [m] of the rollers 44, 46.

Accordingly, AM=c v_{w} η. The proportionality constant c [s⁻¹] depends inter alia on the concrete form of the delivery device 32, for example on the concrete form of the spring steel sheets 52.

This means that, for the same speed of rotation v_{w} of the rollers 44, 46, the discharge mass flow rate AM, for example, is higher, the higher the viscosity η of the separating liquid. At a higher viscosity η, a larger quantity of separating liquid adheres to the rollers 44, 46 as the rollers 44, 46 rotate and is thereby conveyed to the spring steel sheets 52 than in the case of a lower viscosity η of the separating liquid. In other words, the discharge mass flow rate AM of the separating liquid changes when its viscosity η changes.

Because the discharge mass flow rate AM is dependent on the viscosity η of the separating liquid, the total discharge mass flow rate GA is also dependent on the viscosity η of the separating liquid. In general, the delivery device 32 thus delivers separating liquid with the total discharge mass flow rate GM and is so configured that the total discharge mass flow rate GM of the separating liquid is dependent at least on the viscosity η of the separating liquid 58.

The secondary mass flow rate NM of separating liquid from the trough 50 of the delivery device 32 is NM=dm_{NM}/dt [kg s⁻¹].

The feed mass flow rate of separating liquid into the trough 50 of the delivery device 32, that is to say the quantity of separating liquid that flows per unit time from the reservoir 57 into the trough 50, is accordingly ZM=dm_{ZM}/dt [kg s⁻¹].

The level 60 of separating liquid 58 in the trough 50 remains in equilibrium if the condition

ZM=GM=AM+NM

is fulfilled. The separating device is thus operated in such a manner that the feed mass flow rate ZM is equal to the total discharge mass flow rate GM. The viscosity of the separating liquid can then be calculated during operation of the separating device 16, because:

ZM−NM=AM=cv_{w}η

and

η=(ZM−NM)/(cv_{w}).

The viscosity of the separating liquid reflects two properties of the separating liquid that are important and necessary for smooth operation of the separating liquid: On the one hand, the separating liquid must be present in a viscosity range with which it is ensured that the separating liquid flows over the separating surfaces 26 of a separating unit 18 as a cohesive layer and there is no breaking apart of the layer. Otherwise, undesirable flashovers could occur, for example, between the side plates 24 of the separating unit 18 and the electrode devices 40 of the separating device 16. It is essential to avoid this in particular in explosion-protected regions such as painting plants.

A good flow behaviour of the separating liquid can be achieved at a viscosity of the separating liquid which, with a flow cup according to DIN EN ISO 2431, German version EN ISO 2431:1996, from 1996 with a flow opening of 6 mm diameter, gives a measurement between 2 and 100 seconds, preferably between 5 and 20 seconds and particularly preferably of 10.5 seconds.

Moreover, the viscosity of the separating liquid gives information as to whether the regeneration of separating liquid laden with overspray as discussed above was successful. The viscosity of the separating liquid changes when overspray particles are distributed therein.

The feed mass flow rate ZM is adjusted during operation of the separating device 16 and monitored by means of the flow meter 64, so that the feed mass flow rate ZM is known. The secondary mass flow rate NM is determined by means of the measuring device 66 and monitored during operation of the separating device 16 and is thus likewise known.

From those values, the viscosity η of the separating liquid can then be calculated and thereby monitored during operation of the separating device 16. Undesirable changes in the separating liquid, which are reflected in a change in its viscosity, can thereby be counteracted immediately by corresponding reconditioning of the separating liquid in the reservoir 57 in order to restore its starting composition.

In a modification, it is also possible to omit the overflow channel 62 and the determination of the secondary mass flow rate NM of the separating liquid. In this case, separating liquid is discharged from the trough 50 only via the rollers 44, 46. The equilibrium level 60 in the trough 50 can be maintained, for example, by monitoring the level of separating liquid in the trough 50 by means of a filling-level sensor and correspondingly increasing or restricting the mass flow rate of separating liquid via the feed line 56 when the level 60 reaches a lower or upper threshold level.

In this case, the total discharge mass flow rate GM of the delivery device is equal to the roller discharge mass flow rate AM, and the secondary mass flow rate NM is omitted from the above calculation, so that from

ZM=GM=AM=cv_{w}η

the viscosity of the separating liquid is given as

η=ZM/(cv_{w}).

1. Method for separating, using a separating device, overspray produced during the painting of objects comprising:
a) taking the overspray up by an air stream and transporting the overspray to a separating surface of the separating device over which a separating liquid flows, whereby a large part at least of the solids of the overspray is transferred to the separating liquid, is transported away by the separating liquid and is removed from the separating liquid by separation;
b) feeding separating liquid to the separating surface using a delivery device which delivers separating liquid with a total discharge mass flow rate (GM) and is so configured that the total discharge mass flow rate (GM) of the separating liquid is dependent at least on the viscosity (η) of the separating liquid;
wherein
c) separating liquid is fed to the delivery device with a predetermined feed mass flow rate (ZM),
and further wherein
d) the separating device is so operated that the feed mass flow rate (ZM) of the delivery device is equal to the total mass flow rate (GM), and the viscosity (η) of the separating liquid is calculated during operation of the separating device.

2. Method according to claim 1, wherein the discharge of separating liquid to the separating surface is carried out by at least one roller which projects into the separating liquid, and the discharge mass flow rate is AM=c v_{w} η, wherein c is a proportionality factor, v_{w} is a speed of rotation of the roller and η is the viscosity of the separating liquid.

3. Method according to claim 1, wherein the delivery device feeds separating liquid to the separating surface in a first manner with a discharge mass flow rate (AM) which is dependent at least on the viscosity (η) of the separating liquid, and the delivery device delivers separating liquid in at least a second manner with a secondary mass flow rate (NM), and the secondary mass flow rate (NM) is measured with a measuring device during operation of the separating device.

4. Method according to claim 2 wherein the delivery device feeds separating liquid to the separating surface in a first manner with a discharge mass flow rate (AM) which is dependent at least on the viscosity (η) of the separating liquid, and the delivery device delivers separating liquid in at least a second manner with a secondary mass flow rate (NM), and the secondary mass flow rate (NM) is measured with a measuring device during operation of the separating device.
